(19) United States
(12) Patent Application Publication
(10) Pub. No.: US 2005/0211452 A1
(43) Pub. Date: Sep. 29, 2005

(54) Spring powered hand tool

(75) Inventor: Cade Andersen, Kaysville, UT (US)

Correspondence Address: Starkweather and Associates;Suite 200, 9035 South 1300 East, Sandy, UT, 84094, US

(73) Assignee: A MAJOR CORPORATION

(21) Appl. No.: 11/088,418

(22) Filed: Mar. 23, 2005

Related U.S. Application Data
(60) Provisional application No. 60/556,186, filed on Mar. 24, 2004.

(51) Int. Cl. B25D 9/00

(52) U.S. Cl. 173/90; 173/121

(57) ABSTRACT

A novel manually operated tool adapted to introduce a concentrated impact force to a substrate material, at least includes: a base member having an impact ridge, and the base member having a impact member void to receive an impact member; a hammer member, coupled to a handle member, the hammer member having a hollow section and having a step protruding into the hollow section, the hammer member adapted to transfer an impact force to the base member; a spring member operatively coupled to the hammer member and to the base member, the spring member adapted to provide a resistive force when the hammer member is pulled away from the base member via the handle member; and a rod member coupled at one of its ends to the base member, slidably engaged within the hollow section of the hammer member, and the rod member having a lip at its other end, the lip and the step adapted to limit the axial travel of the hammer member when the handle member is pulled away from the base member in a cocked position. The hammer member is adapted to, upon being released from the cocked position, and the spring member retracting, impart the impact force to the base member via the impact ridge, which impact force is transmitted to the impact member to cause the impact member to strike the substrate material.

### CROSS-REFERENCES TO RELATED APPLICATIONS

This application claims priority to U.S. Provisional Patent Application No. 60/556,186 entitled “Spring Powered Hand Tool,” and filed on Mar. 24, 2004.

### BACKGROUND OF THE INVENTION

1. Field of the Invention

The present invention generally relates to apparatuses for introducing decorative holes, eyelets, impressions, snaps, grommets, brads, and the like to substrate materials such as paper, cardboard, and fabric.

2. Description of the Related Art

Various approaches are used for punching decorative holes through substrate material such as paper, cardboard, plastic, and fabric. These include dual-lever devices such as hole punches that operate similarly in movement to pliers. When the dimensions of such hole punch devices are small enough to be comfortably held, an insufficient mechanical advantage may exist for piercing thick or hard substrate materials.

Further, large hole punch devices can be heavy and cumbersome to use.

Other approaches include using a finishing hammer combined with various punches, awls, and the like. Besides being limited in the hole shapes possible, the latter approach is more likely to result in injury to the user.

In view of the above, what is needed but lacking in the prior art is a hand tool for safely, conveniently and reliably introducing decorative holes to hard, tough, or thick substrate materials. Also lacking is a hand tool for safely, conveniently and reliably installing and splaying “through-substrate” items, such as eyelets, embellishments, grommets and the like.

The same is desired for a hand tool for providing decorative imprints and impressions on hard, tough, or thick substrate materials.

### SUMMARY OF THE INVENTION

The present invention has been developed in response to the present state of the art, and in particular, in response to the problems and needs in the art that have not yet been fully solved. Accordingly, the present invention has been developed to provide a manually operated tool adapted to introduce a concentrated impact force to a substrate material, the tool at least including: a base member having an impact ridge, and the base member having a impact member void to receive an impact member; a hammer member, coupled to a handle member, the hammer member having a hollow section and having a step protruding into the hollow section, the hammer member adapted to transfer an impact force to the base member; a spring member operatively coupled to the hammer member and to the base member, the spring member adapted to provide a resistive force when the hammer member is pulled away from the base member via the handle member; and a rod member coupled at one of its ends to the base member, slidably engaged within the hollow section of the hammer member, and the rod member having a lip at its other end, the lip and the step adapted to limit the axial travel of the hammer member when the handle member is pulled away from the base member in a cocked position.

The hammer member is adapted to, upon being released from the cocked position, and the spring member retracting, impart the impact force to the base member via the impact ridge, which impact force is transmitted to the impact member to cause the impact member to strike the substrate material.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view of the present-inventive spring powered hand tool with its spring member in the retracted position;

FIG. 2 is an exploded side view of the present-inventive spring powered hand tool, with some portions shown in cutaway; and

FIG. 3 is a cutaway side view of the present-inventive spring powered hand tool with its spring member in the cocked/extended position.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

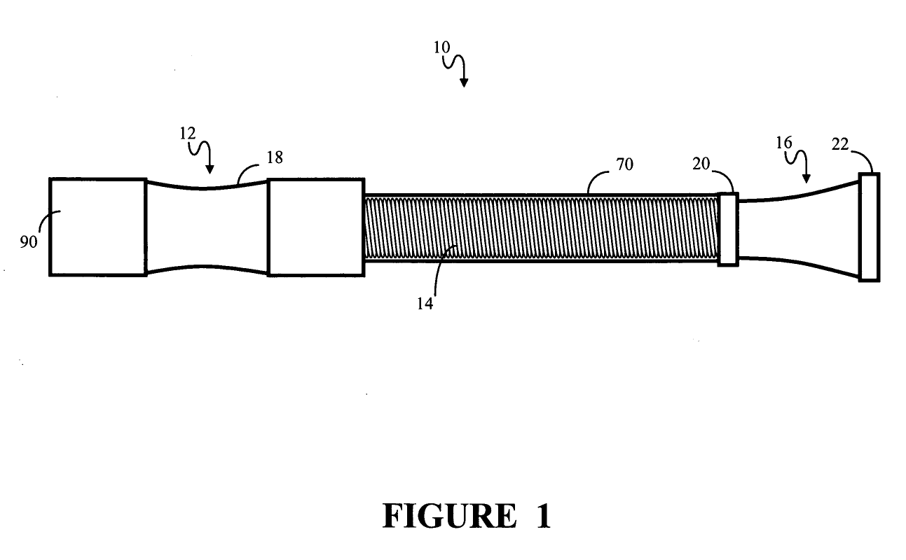

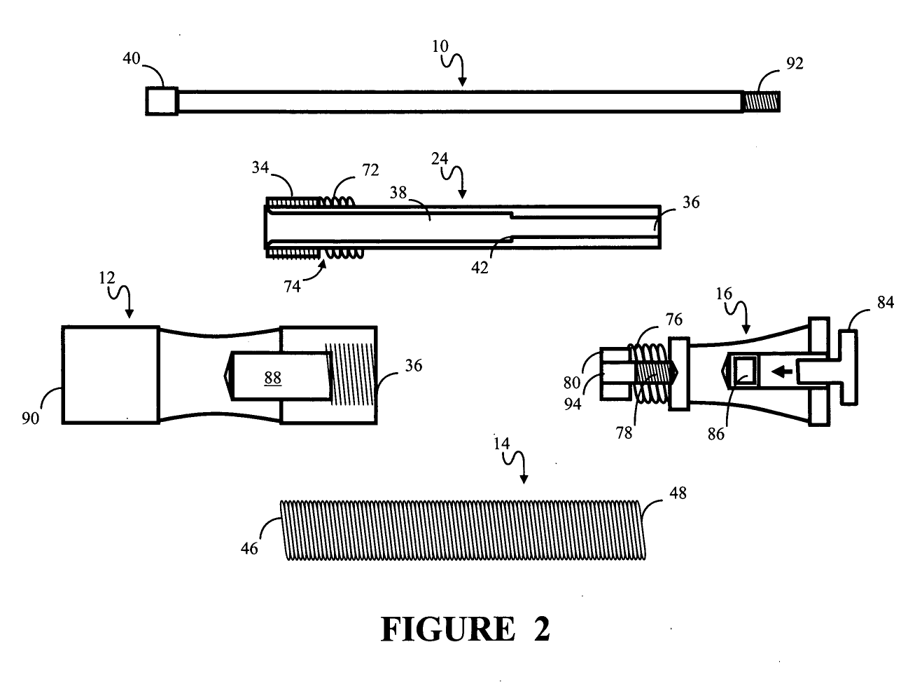

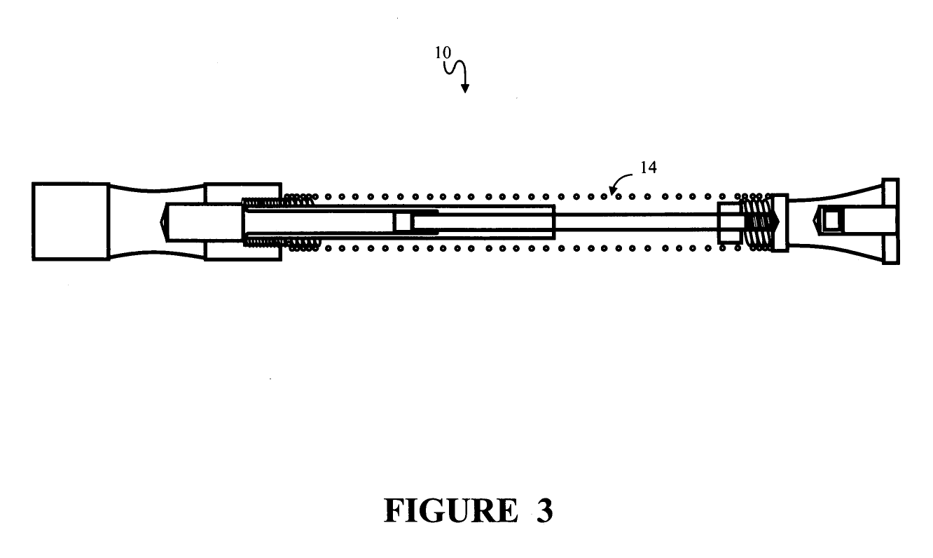

FIG. 1 illustrates the side view of the present-inventive spring powered hand tool 10. The spring powered hand tool 10 nominally includes a handle member 12 with a recessed area 18 for improving a user's grip on the handle member, a base member 16 with top and bottom rings 10 and 22, respectively, also for improving a user's grip, a spring member 14, and a hammer member 24 (see FIGS. 2 and 3) connected to the handle member and concealed by the spring member. A spring member cover 70 also covers the spring member in one embodiment of the present invention to prevent the spring member from pinching a user's hands (or flesh in the vicinity of the hands).

The base member has a hollow for receiving a punch/impact member (further discussed infra.). In the basic hand tool operation, the base member 16 is placed over a substrate material which is to be punched or receive an imprint. The user grasps the base member and the handle member and pulls the handle member away from the base member until the two are sufficiently far apart to have significant spring energy as a result of the spring member being stretched to a cocked position. When the handle member is released, the hammer member accelerates toward the base member. When the hammer member strikes the base member, the hammer member's momentum is transferred to the based member to create an impulse force which is transmitted to the impact member. The impulse force drives the impact member to create a hole in the substrate material, or create an imprint in the alternative.

The exploded view in FIG. 2 shows the spring powered hand tool 10 in more detail. From FIG. 2, it is shown that the hammer member 24 has on one end, male threads 34, which allow the hammer member to be screwed into handle member receiving threads 36 of a handle member hollow 88 for construction. The spring member 14 is attached at its end 46 to the hammer member by setting the end within a lock groove 74 and threading the spring over hammer spring threads 72, which are larger in pitch than the pitch of the spring. This provides a secure connection between the spring member and the hammer member.

In the preferred embodiment, the end 90 of the handle member is both flat, and massive enough to provide the desired momentum needed to properly drive an impact member 84 into the substrate material.

A rod member or guide rod member 26 is positioned within hollow sections 36 and 38 of the hammer member 24 to maintain alignment of the hammer member 24 and the base member 16 during operation. Guide member male threads 92 screw into base member receiving threads 78 of a base member hollow 94. The extended length of the hollow 94 prevents the guide rod member from being overly stressed at the junction between the threads 92 and the body of the rod. A second end 48 of the spring member 14 is secured to the base member by threading the spring over base spring threads 76.

An impact ridge 80 of the base member receives the initial impact from the hammer member after the handle member is released from the cocked position, and then transmits the impact force to punch/impact member 84. Given the teachings of the present invention, there are numerous ways to attach a punch/impact member to the base member. In the example shown, the impact member is fastened through an impact member hollow 82 to a magnetic coupler 86. The impact member may also be connected to the base member via threads, slots, and the like.

The base member 16 can also be covered by or coated with a soft membrane or the like to provide more comfort to the user during punching operations.

So that when the spring powered hand tool 10 will not be pulled apart to failure when extending the handle (and the hammer) to prepare for an impact operation, the guide rod member 26 contains a guide rod member stop 40 which limits the axial displacement of the hammer when the stop 40 reaches the step 42.

FIG. 3 illustrates a cutaway view of the spring powered hand tool in the cocked position. Another feature of the present-inventive spring powered hand tool 10 is that the spring member 14 is not allowed to completely retract, thereby leaving small gaps between the turns of the spring when the hand tool is in the non-cocked state. By leaving small gaps, pinching of the user's skin during operation of the tool is eliminated or greatly reduced. This is partially accomplished by carefully choosing the spring length so that it is slightly shorter than the hammer member in the preferred embodiment.

An added benefit of the flat shape of the handle end 90 and its relatively large mass, is the ability of the spring powered tool 10 to be used more as a conventional hammer by inverting the tool ends with respect to the substrate material. For example, splaying of eyelets can be carried out by hammering to spread out inserted eyelet metal when needed.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A manually operated tool adapted to introduce a concentrated impact force to a substrate material, said tool comprising:
a base member having an impact ridge, and said base member having a impact member void to receive an impact member;
a hammer member, coupled to a handle member, said hammer member having a hollow section and having a step protruding into the hollow section, said hammer member adapted to transfer an impact force to said base member;
a spring member operatively coupled to said hammer member and to said base member, said spring member adapted to provide a resistive force when said hammer member is pulled away from said base member via said handle member; and
a rod member coupled at one of its ends to said base member, slidably engaged within the hollow section of said hammer member, and said rod member having a lip at its other end, said lip and said step adapted to limit the axial travel of said hammer member when the handle member is pulled away from said base member in a cocked position;
wherein said hammer member is adapted to, upon being released from said cocked position, and said spring member retracting, impart said impact force to said base member via said impact ridge, which impact force is transmitted to said impact member to cause said impact member to strike said substrate material.

2. The tool of claim 1, wherein said handle member is adapted to be grasped by one hand of a user, and said base member is adapted to be grasped by a user's other hand.

3. The tool of claim 1, wherein said spring member retracts less than fully when released from a cocked position to reduce the likelihood of said spring member binding with a user's person or items associated with a user's person.

4. The tool of claim 1, further comprising:
a magnetic coupler adapted to magnetically couple said impact member to said base member.

5. The tool of claim 1, further comprising:
a screw coupler adapted to couple said impact member to said base member.

6. The tool of claim 1, further comprising:
a slotted coupler adapted to slottably couple said impact member to said base member.

7. The tool of claim 1, further comprising:
a flexible spring member cover adapted to cover said spring member and prevent direct contact of the user's person with said spring member.

8. The tool of claim 1, wherein said handle member further comprises:
a weighted member adapted to increase the effective momentum of said hammer member when said hammer member is released from a cocked position.

9. The tool of claim 8, wherein said weighted member is further adapted to be used as a finishing hammer when inverting said tool relative to said substrate material.

10. The tool of claim 9, wherein the distal end of said weighted member is substantially flat.

11. The tool of claim 1, wherein said rod member and said lip are molded as one member.

12. The tool of claim 1, further comprising:
soft membrane coupled to the outside of said base member, said soft membrane adapted to lessen the radiating forces received by a hand gripping said base member during the impact of said hammer member on said impact ridge.

13. The tool of claim 1, wherein said concentrated impact force is adapted to punch a void through said substrate material.

14. The tool of claim 13, wherein the void through said substrate material has a decorative shape.

15. The tool of claim 1, wherein said concentrated impact force is adapted to create an impression on said substrate material.

16. The tool of claim 15, wherein the impression on said substrate material has a decorative shape.
